(19) United States
(12) Patent Application Publication
(10) Pub. No.: US 2024/0073575 A1
(43) Pub. Date: Feb. 29, 2024

(54) INTRA-AURAL EARBUD

(71) Applicant: David Clark Company Incorporated, Worcester, MA (US)

(72) Inventors: Eric Motler, Northborough, MA (US); Brad Deschenes, Dudley, MA (US)

(73) Assignee: David Clark Company Incorporated, Worcester, MA (US)

(21) Appl. No.: 17/895,627

(22) Filed: Aug. 25, 2022

(51) Int. Cl. H04R 1/10

(52) U.S. Cl. CPC H04R 1/1016

(57) ABSTRACT

An insert assembly is provided having a sleeve configured to receive an insert. The sleeve includes an undercut feature resting on a mating surface on the outside of the insert. The insert having a concentric rib on its outer diameter. The mating surface provides friction between the sleeve and the insert by at least partial encapsulation of the sleeve using the undercut feature, retaining the insert within the sleeve. The mating surface includes a multi-level surface that interlocks the sleeve and the insert.

### BACKGROUND

Traditional earplug style headphones have earbuds that slide over a hard plastic post attached to the earbud's body. This post usually contains a concentric rib that interfaces with the elastic ear tip. Each elastic ear tip has the same mating feature, so all sizes are retained consistently on the plastic earbud. The portion of the earbud that contacts the ear can cause occlusion in the user's ear, distorting sound and providing an uncomfortable experience. Retention is also an issue because the ear canal is often the sole mating surface for these devices. The retention scheme utilized in previous in-ear headsets exerts a large amount of force on pressure points in the ear canal, making them uncomfortable.

The fit achieved by in-ear monitors requires that each headset be custom-made, adding cost and time to the production process. These are not mass producible. Aviation and consumer headsets that do not use the earplug style tips use a flexible interface over a hard insert. This variation of the ear plug design can lead to unwanted occlusion and pressure points throughout the ear.

There is a need for an earbud that provides reliable retention while maintaining a low profile.

### SUMMARY

According to one aspect of the subject matter described in this disclosure, an insert assembly is provided. The insert assembly includes a sleeve configured to receive an insert. The sleeve includes an undercut feature resting on a mating surface on the outside of the insert. The insert having a concentric rib on its outer diameter. The mating surface provides friction between the sleeve and the insert by at least partial encapsulation of the sleeve using the undercut feature, retaining the insert within the sleeve. The mating surface includes a multi-level surface that interlocks the sleeve and the insert.

According to another aspect of the subject matter described in this disclosure, an earbud is provided. The earbud includes at least one interchangeable sleeve configured to be stretched over an insert providing consistent fits for multiple ear sizes. The at least one interchangeable sleeve has at least a first protruding section for retention of the insert in an ear of a user.

According to another aspect of the subject matter described in this disclosure, a method for forming an earbud is provided. The method includes providing a sleeve configured to receive an insert. The sleeve has an undercut feature resting on a mating surface on the outside of the insert. The insert includes a concentric rib on its outer diameter. Also, the method includes delivering, using the mating surface, friction between the sleeve and the insert. Moreover, the method includes retaining the insert within the sleeve by at least partially encapsulating the sleeve by the undercut feature. The mating surface comprises a multi-level surface that interlocks the sleeve and the insert.

Additional features and advantages of the present disclosure is described in, and will be apparent from, the detailed description of this disclosure.

### BRIEF DESCRIPTION OF THE DRAWINGS

The disclosure is illustrated by way of example, and not by way of limitation, in the figures of the accompanying drawings in which like reference numerals are used to refer to similar elements. It is emphasized that various features may not be drawn to scale and the dimensions of various features may be arbitrarily increased or reduced for clarity of discussion.

FIG. 1A-1B are schematic diagrams of a hard insert, in accordance with some embodiments.

FIG. 2A-2C are schematic diagrams of an intra-aural earbud, in accordance with some embodiments.

FIG. 3 is a schematic diagram of a cross-sectional view of a sleeve 300 used in an intra-aural earbud, in accordance with some embodiments.

FIG. 4 is a flowgraph of a process for forming an earbud, in accordance with some embodiment.

### DETAILED DESCRIPTION

The figures and descriptions provided herein may have been simplified to illustrate aspects that are relevant for a clear understanding of the herein described devices, systems, and methods, while eliminating, for the purpose of clarity, other aspects that may be found in typical similar devices, systems, and methods. Those of ordinary skill may recognize that other elements and/or operations may be desirable and/or necessary to implement the devices, systems, and methods described herein. But because such elements and operations are well known in the art, and because they do not facilitate a better understanding of the present disclosure, a discussion of such elements and operations may not be provided herein. However, the present disclosure is deemed to inherently include all such elements, variations, and modifications to the described aspects that would be known to those of ordinary skill in the art.

The terminology used herein is for the purpose of describing particular example embodiments only and is not intended to be limiting. For example, as used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

Although the terms first, second, third, etc., may be used herein to describe various elements, components, regions, layers and/or sections, these elements, components, regions, layers and/or sections should not be limited by these terms. These terms may be only used to distinguish one element, component, region, layer or section from another element, component, region, layer or section. That is, terms such as “first,” “second,” and other numerical terms, when used herein, do not imply a sequence or order unless clearly indicated by the context.

This disclosure is directed to an intra-aural earbud for a hard insert. The intra-aural earbud is designed to be a well-retained but replaceable earbud on top of a hard insert. Moreover, the intra-aural earbud provides a comfortable interface between a hard insert and the user. The intra-aural earbud is configured to allow the user to apply the intra-aural earbud to the hard insert using a sleeve arrangement.

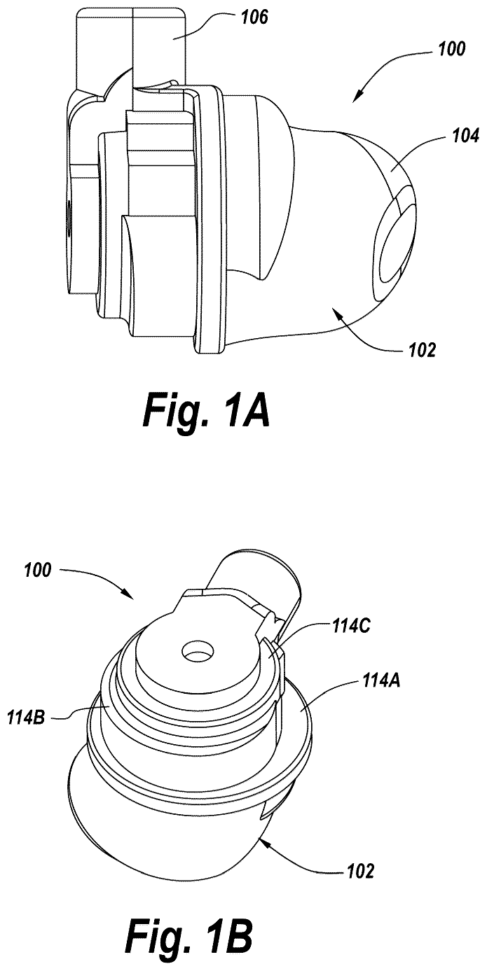

FIG. 1A-4B are schematic diagrams of a hard insert 100, in accordance with some embodiments. FIG. 1A shows hard insert 100 having a hard/rugged plastic outer surface 102 forming a hard insert to protect its internal components. The hard insert 100 has a hardness of at least 15 SHORE D. The internal components of hard insert 100 include electronics (i.e., microprocessors, receivers/transmitters, etc.), a speaker, a microphone, a battery, or the like positioned at fixed locations in hard insert 100. The hard insert 100, as shown, has an ear canal portion 104 designed to rest within the ear canal of a user. Moreover, the hard insert 100 includes a hard plastic post 106 configured to optionally receive a support mechanism to allow a user to comfortably wear or position hard insert 100 on a user's ear.

In some embodiments, the support mechanism is an ear hook with a plastically deformable inner core allowing a user to form the ear hook to fit his/her ear. This ear hook can also house electronics such as bone conduction sensors.

FIG. 1B is a schematic diagram of the bottom view of hard insert 100, in accordance with some embodiments. The hard insert 100 includes several concentric ribs 114A-114B on the outer diameter of hard insert 100, and shelf feature 114C configured to be a concentric face of hard insert 100.

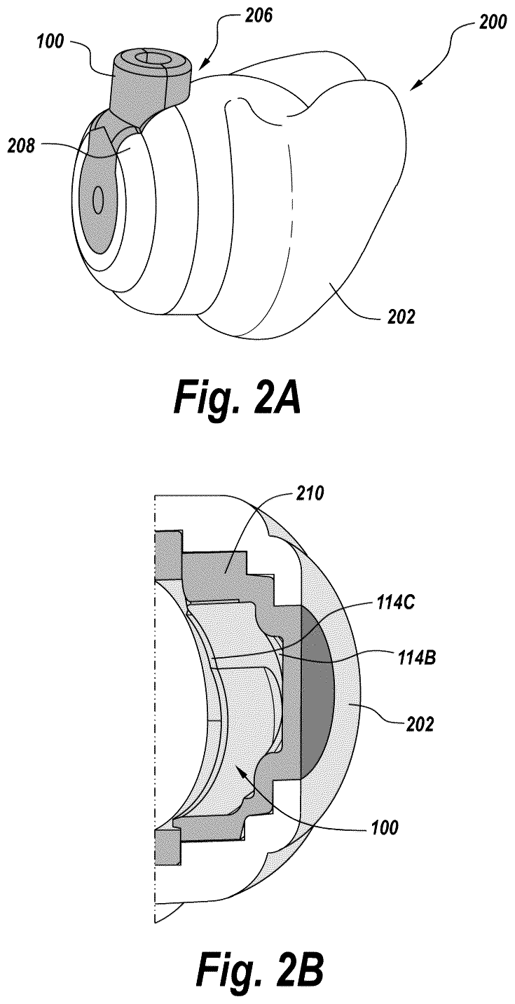

FIG. 2A-2C are schematic diagrams of an intra-aural earbud 200, in accordance with some embodiments. In particular, FIG. 2A shows intra-aural earbud 200 includes a sleeve 202 configured to receive hard insert 100. The sleeve 202 uses an undercut feature 208 to wrap around hard insert 100. Features in hard insert 100 keep the sleeve flush with the outer plastic face of hard insert 100. The elasticity of sleeve 202 is such that it is allowed to be stretched around hard insert 100. The rear face of hard insert 100 that protrudes outside the user's ear has shelf feature 114C and concentric rib 114A to catch the undercut feature 208 on sleeve 202. The undercut feature 208 of sleeve 200 is stretched around hard insert 100 as sleeve 202 is being installed.

When hard insert 100 has been fully installed in sleeve 202, the undercut feature 208 rests on its mating flat surface 208 on the outside of hard insert 100. Flat surface 208 provides friction between hard insert 100 and sleeve 202 that, aided by the encapsulation of hard insert 100 by undercut feature 208, retains hard insert 100 within sleeve 202. FIG. 2B shows a multi-level mating surface 210 being configured as a puzzle piece type interface that interlocks sleeve 202 and hard insert 100 via concentric ribs 114B and 114C. Between hard insert 100 and sleeve 202 is an open space 206 used for positioning hard insert 100.

FIG. 2C is a schematic diagram of a front view of intra-aural earbud 200, in accordance with some embodiments. The intra-aural earbud 200 includes an ear canal portion 226 designed to rest within the ear canal of a user. The intra-aural earbud 200 also has a concha bowl portion 228 and a concha cymba portion 230, designed to rest against the concha bowl and concha cymba, respectively, of a user's ear. In some particular exemplary embodiments, the ear canal portion 226 has a length in the range between 8-12 mm. In some exemplary embodiments, this range may be larger. Normally, the ear canal portion 226 is between 8-10 mm in length in a standard size. The ear canal portion 226 is sized to receive ear canal portion 104 of hard insert 100.

The concha cymba portion 230 can also be designed to maximize grip strength. Generally, a softer concha cymba portion 230 improves its grip once inserted into the ear, but higher compressibility results in a better fit. Concha cymba portion 230 does not provide the main forces that retain the assembly in the user's ear. Most retention is achieved through the combination of ear canal portion 226, sleeve 202, concha bowl portion 228, and concha cymba portion 230. The concha bowl portion 228 can be configured for an environment where maximizing grip strength is desired. Again, materials of different stiffness can be used to conform to idiosyncrasies of a variety of ear anatomies.

The intra-aural earbud 200 is designed to be interchangeable, ensuring fit for everyone. Sleeve 202 is preferably made with low durometer silicone coupled with a hard insert to avoid pressure points. In some embodiments, materials that perform similarly to silicone may be used. In some exemplary embodiments, sleeve 202 is made with high durometer silicone.

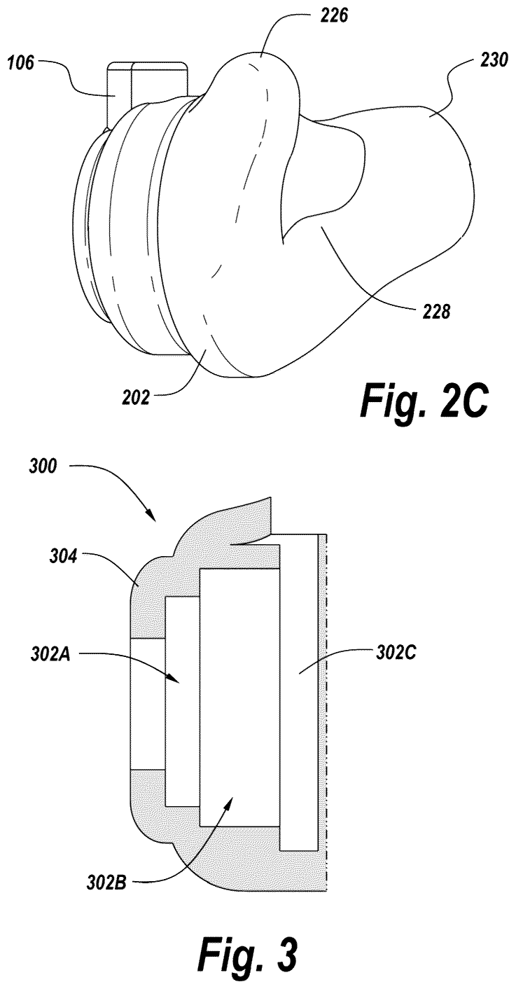

FIG. 3 is a schematic diagram of a cross-sectional view of a sleeve 300 used in an intra-aural earbud, in accordance with some embodiments. The sleeve 300 is substantially similar to sleeve 202 of FIG. 2. In this case, the sleeve 300 includes an outer surface 304 and concentric cavities 302A-302C. The concentric cavities 302A, 302B, and 302C interface with concentric ribs 114A and 114B, and shelf feature 114C of hard insert 100, respectively. Sleeve 300 is stretched, so concentric ribs 114A and 114B are positioned in concentric cavities 302A and 302B. Shelf feature 114C is positioned in concentric cavity 302C, which is used to catch the undercut feature of sleeve 300. This interlocks sleeve 300 and hard insert 100 and maintains sleeve retention.

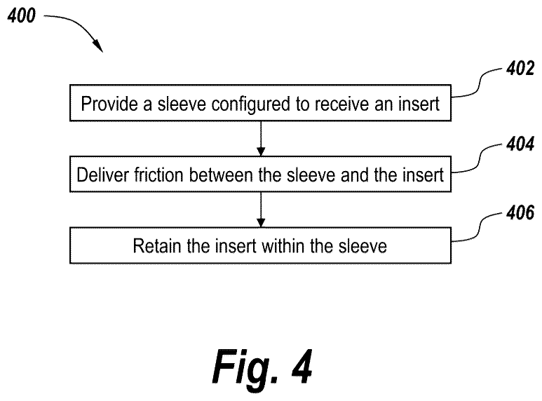

FIG. 4 is a flowgraph of a process 400 for forming an earbud, in accordance with some embodiment. Process 400 includes providing a sleeve (such as sleeve 200 or 300) configured to receive an insert (such as hard insert 100)(Step 302). The insert has a concentric rib (such as concentric rib 114A. 114B, or 114C) on its outer diameter. The sleeve includes an undercut feature (such as undercut 206) resting on a mating surface (such as mating flat surface 208) outside the insert. Process 400 includes delivering, using the mating surface, friction between the sleeve and the insert (Step 304). Process 400 includes retaining the insert within the sleeve by at least partially encapsulating the sleeve with the undercut feature (Step 306). The mating surface includes a multi-level surface (such as multi-level mating surface 210) that interlocks the sleeve and the insert, using the rib and the undercut feature.

The disclosure described an intra-aural earbud having a sleeve used in conjunction with a hard insert. In some exemplary embodiments, the intra-aural earbud includes a low-durometer silicone sleeve that avoids pressure points. The advantages of the intra-aural earbud include reliable retention of a variety of sleeves (silicone ear interface) that fill the volume of the concha and the auditory canal while maintaining a low profile. Also, the sleeves are retained to ensure they remain on the hard insert. Moreover, the intra-aural earbud provides the user with a more comfortable experience. The flexibility of the sleeve offers a fit comparable to studio monitors without the need for custom forming. In addition, the sleeves are interchangeable to ensure fit for all people.

Reference in the specification to “one implementation” or “an implementation” means that a particular feature, structure, or characteristic described in connection with the implementation is included in at least one implementation of the disclosure. The appearances of the phrase “in one implementation,” “in some implementations,” “in one instance,” “in some instances,” “in one case,” “in some cases,” “in some exemplary embodiments,” “in one embodiment,” or “in some embodiments” in various places in the specification are not necessarily all referring to the same implementation or embodiment.

Finally, the above descriptions of the implementations of the present disclosure have been presented for the purposes of illustration and description. It is not intended to be exhaustive or to limit the present disclosure to the precise form disclosed. Many modifications and variations are possible in light of the above teaching. It is intended that the scope of the present disclosure be limited not by this detailed description, but rather by the claims of this application. As will be understood by those familiar with the art, the present disclosure may be embodied in other specific forms without departing from the spirit or essential characteristics thereof. Accordingly, the present disclosure is intended to be illustrative, but not limiting, of the scope of the present disclosure, which is set forth in the following claims.

What is claimed is:

1. An insert assembly comprising:
a sleeve configured to receive an insert, the sleeve having an undercut feature resting on a mating surface on the outside of the insert, the insert having a concentric rib on its outer diameter, the mating surface providing friction between the sleeve and the insert by at least partial encapsulation of the sleeve using the undercut feature, retaining the insert within the sleeve, wherein the mating surface comprises a multi-level surface that interlocks the sleeve and the insert.

2. The insert assembly of claim 1, wherein the sleeve comprises a low durometer material.

3. The insert assembly of claim 1, wherein the sleeve avoids pressure points formed by in an ear of a user by the insert.

4. The insert assembly of claim 1, wherein the sleeve comprises a first portion positioned in an ear canal of a user.

5. The insert assembly of claim 4, wherein the sleeve comprises a second portion positioned on a concha bowl region of an ear of the user.

6. The insert assembly of claim 5, wherein the second portion receives an ear canal portion of the insert.

7. The insert assembly of claim 6, wherein the sleeve comprises a third portion positioned on a concha cymba region of the ear of the user.

8. An earbud comprising:
at least one interchangeable sleeve configured to be stretched over an insert providing consistent fits for multiple ear sizes, wherein the at least one interchangeable sleeve comprises at least a first protruding section for retention of the insert in an ear of a user.

9. The earbud of claim 8, wherein the at least one interchangeable sleeve comprises a low durometer material.

10. The earbud of claim 8, wherein the at least one interchangeable sleeve avoids pressure points formed by in an ear of a user by the insert.

11. The earbud of claim 8, wherein the first protruding section is positioned in the ear canal of the user.

12. The earbud of claim 13, wherein the at least one interchangeable sleeve comprises a second section positioned on a concha bowl region of an ear of the user.

13. The earbud of claim 14, wherein the second section receives an ear canal portion of the insert.

14. The earbud of claim 14, wherein the at least one interchangeable sleeve comprises a third protruding section positioned on a concha cymba region of the ear of the user.

15. A method for forming an earbud comprising:
providing a sleeve configured to receive an insert, the sleeve having an undercut feature resting on a mating surface on the outside of the insert, the insert having a concentric rib on its outer diameter;
delivering, using the mating surface, friction between the sleeve and the insert; and
retaining the insert within the sleeve by at least partially encapsulating the sleeve by the undercut feature, wherein the mating surface comprises a multi-level surface, that interlocks the sleeve and the insert.

16. The method of claim 15, wherein sleeve comprises a low durometer material.

17. The method of claim 15, wherein retaining the insert within the sleeve comprises avoiding, using the sleeve, pressure points formed by in an ear of a user by the insert.

18. The method of claim 15, wherein sleeve comprises a first portion positioned in an ear canal of a user.

19. The method of claim 18, wherein the sleeve comprises a second portion positioned on a concha bowl region of an ear of the user.

20. The method assembly of claim 19, wherein the sleeve comprises a third portion positioned on a concha cymba region of the ear of the user.
